(19) United States
(12) Patent Application Publication
(10) Pub. No.: US 2015/0275083 A1
(43) Pub. Date: Oct. 1, 2015

(54) SILICATE LUMINESCENT MATERIAL AND PREPARATION METHOD THEREFOR

(71) Applicants: OCEAN'S KING LIGHTING SCIENCE & TECHNOLOGY CO., LTD, Shenzhen (CN); SHEN ZHEN OCEAN'S KING LIGHTING ENGINEER CO. LTD, Shenzhen (CN)

(72) Inventors: Mingjie Zhou, Shenzhen (CN); Rong Wang, Shenzhen (CN)

(21) Appl. No.: 14/438,510

(22) PCT Filed: Oct. 31, 2012
(86) PCT No.: PCT/CN2012/083878

§ 371 Date: Apr. 24, 2015

(51) Int. Cl. C09K 11/87; C09K 11/77

(52) U.S. Cl. CPC C09K 11/87; C09K 11/7749

(57) ABSTRACT

A silicate luminescent material has a general molecular formula of Li₂Ca₁₋ₓSiO₄:Tbₓ,M_{y} is provided, of which M is selected from at least one of Ag, Au, Pt, Pd, and Cu metal nanoparticles, x is in a range of 0<x≦0.2, M is doped in Li₂Ca₁₋ₓSiO₄:Tbₓ, y is a molar ratio of M to Si and y is in a range of 0<y≦1×10⁻². The metal nanoparticles M which doped in the silicate luminescent material can improve internal quantum efficiency of the luminescent material, thereby improving luminescent intensity of the silicate luminescent material. In addition, the silicate luminescent material can prevent a phenomenon where luminescent efficiency of the luminescent material is reduced because a traditional sulfide and sulfur oxide decompose during use and sediment generated in decomposition covers a surface of the luminescent material, and has high stability. A preparation method thereof is also provided.

### FIELD OF THE INVENTION

The present invention relates to luminescent material technology. More particularly, the invention relates to a silicate luminescent material and preparation method thereof.

### BACKGROUND OF THE INVENTION

In the 1960s, Ken Shoulder proposed ideas based on field emissive arrays (Field Emissive Arrays, FEAs) electron beam microelectronic devices, thus, to design and produce panel display and light resource devices (Field Emission Display, FED) by using FEAs has drawn the public's attention. Similar to the working principle of conventional cathode ray tube (Cathode Ray Tube, CRT), such new field emission display lights and forms images by electron beam bombardment on red, green blue trichromatic fluorescent powder. Field emission display has potential advantages in luminance, visual angle, response time, working temperature range, energy consumption and other aspects.

A key factor to prepare field emission display of high performances is to prepare luminescent material of excellent performance. At present, luminescent material provided in field emission display are commonly luminescent material of traditional cathode ray tube and projection television kinescope, such as sulfide series, and oxysulfide series luminescent material. As for sulfide series and oxysulfide series luminescent material, they have high luminance and electrical conductivity, but, under the large electron beam bombardment, they prone to decompose into elemental sulfur, which can poison the tip of cathode and produce other precipitates covering the luminescent material, so as to reduce the luminescent efficiency of luminescent material, and shorten the life of a field emission display.

### SUMMARY OF THE INVENTION

In view of this, the present invention provides a silicate luminescent material and preparation method thereof, said silicate luminescent material has high luminescent intensity and good stability.

A silicate luminescent material, wherein said silicate luminescent material has a general molecular formula of Li₂Ca₁₋ₓSiO₄:Tbₓ,M_{y}, M is selected from at least one of Ag, Au, Pt, Pd, and Cu metal nanoparticles, x is in a range of 0<x≦0.2, M is doped in the silicate luminescent material, and y is a molar ratio of M to Si and y is in a range of 0<y≦1×10⁻².

In one embodiment of the present invention, x is in a range of 0.02≦x≦0.10.

In one embodiment of the present invention, y is in a range of 1×10⁻⁵≦y≦5×10⁻³.

A method for preparing a silicate luminescent material, comprising:

preparing collosol containing M, said M is selected from at least one of Ag, Au, Pt, Pd, and Cu metal nanoparticles;

mixing said collosol containing M and silicon dioxide aerogel to obtain mixture solution, stirring said mixture solution and then sonicating and drying, grinding solid material obtained from drying, calcining said solid material at 600° C. to 1200° C. for 0.5 to 4 hours to obtain silicon dioxide aerogel containing M;

selecting source compound of Li, source compound of Ca, source compound of Tb and said silicon dioxide aerogel containing M according to stoichiometric ratios of corresponding elements in general molecular formula of Li₂Ca₁₋ₓSiO₄:Tbₓ,M_{y}, mixing and grinding uniformly to form a mixture material, calcining said mixture material at 500° C. to 1000° C. for 2 to 15 hours, and reducing said mixture material at 800° C. to 1200° C. for 0.5 to 6 hours, cooling and grinding to obtain silicate luminescent material has a general molecular formula of Li₂Ca₁₋ₓSiO₄:Tbₓ,M_{y}, x is in a range of 0<x≦0.2, M is doped in said Li₂Ca₁₋ₓSiO₄:Tbₓ, and y is a molar ratio of M to Si and y is in a range of 0<y≦1×10⁻².

In one embodiment of the present invention, said preparing collosol containing M comprising:

mixing at least one solution of salt selected from silver salt solution, gold salt solution, platinum salt solution, palladium salt solution and copper salt solution, with assistant agent and reducing agent to have reaction for 10˜45 minutes to obtain collosol containing M.

In one embodiment of the present invention, a concentration of at least one solution of salt selected from silver salt solution, gold salt solution, platinum salt solution, palladium salt solution and copper salt solution is in a range of 5×10⁻⁴ mol/L to 2.5×10⁻² mol/L.

In one embodiment of the present invention, said assistant agent is selected from at least one of polyvinyl pyrrolidone, sodium citrate, cetyl trimethyl ammonium bromide, sodium dodecyl sulfate and sodium dodecyl sulfonate.

A concentration of said assistant agent in collosol containing M is in a range of 1×10⁻⁴ g/mL to 5×10⁻² g/mL.

Said reducing agent is selected from at least one of hydrazine hydrate, ascorbic acid, sodium citrate and sodium borohydride.

A molar ratio of said reducing agent to metal ion in at least one solution of salt selected from silver salt solution, gold salt solution, platinum salt solution, palladium salt solution and copper salt solution is in a range of 0.5:1 to 10:1.

In one embodiment of the present invention, said stirring mixture solution and then sonicating and drying comprising: stirring said mixture solution at 50° C. to 75° C. for 0.5 to 3 hours, and sonicating for 10 minutes, then drying at 60° C. to 150° C.

In one embodiment of the present invention, said source compound of Li is one of lithium oxide, lithium carbonate, lithium nitrate, lithium acetate and lithium oxalate, said source compound of Ca is one of calcium oxide, calcium carbonate, calcium nitrate, calcium acetate and calcium oxalate, and said source compound of Tb is one of terbium oxide, terbium carbonate, terbium nitrate, terbium acetate and terbium oxalate.

In one embodiment of the present invention, said reducing at 800° C. to 1200° C. for 0.5 to 6 hours comprising: reducing under reducing atmosphere at 800° C. to 1200° C. for 0.5 to 6 hours, and said reducing atmosphere is selected from at least one of mixed gases of N₂ and H₂ reducing atmosphere, CO reducing atmosphere, and H₂ reducing atmosphere.

The metal nanoparticles M which doped in the silicate luminescent material can improve internal quantum efficiency of the luminescent material, thereby improving luminescent intensity of the silicate luminescent material. In addition, the silicate luminescent material can prevent a phenomenon where luminescent efficiency of the luminescent material is reduced because a traditional sulfide and sulfur oxide decompose during use and sediment generated in decomposition covers a surface of the luminescent material, and has high stability.

### BRIEF DESCRIPTION OF THE DRAWINGS

FIG. 1 is a flow chart of the preparation method for silicate luminescent material of one embodiment.

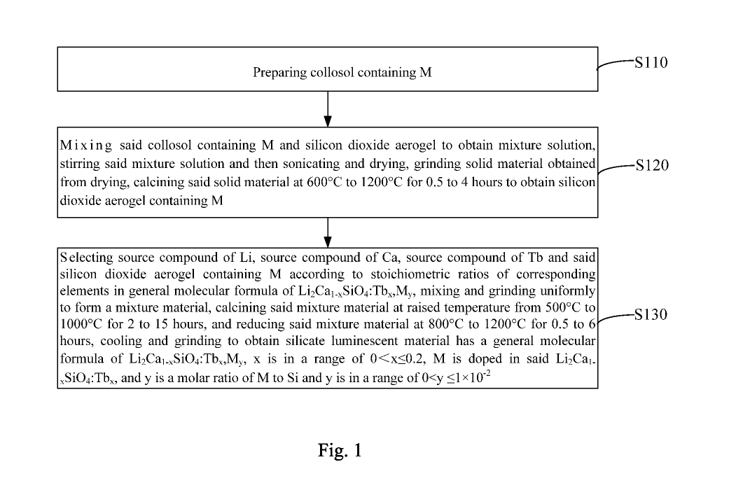

FIG. 2 is a cathodoluminescence spectrum of silicate luminescent material Li₂Ca_{0.90}SiO₄:Tb_{0.10},Ag_{2.5×10}−4 excited by cathode ray under 3 kv acceleration voltage in Example 3 with respect to silicate luminescent material Li₂Ca_{0.90}SiO₄:Tb_{0.10} which is tested under the same conditions.

### DETAILED DESCRIPTION OF ILLUSTRATED EMBODIMENTS

Further description of the silicate luminescent material and preparation method therefor will be illustrated combined with embodiments and drawings.

In one embodiment of the present invention, a silicate luminescent material, wherein said silicate luminescent material has a general molecular formula of Li₂Ca₁₋ₓSiO₄:Tbₓ,M_{y}.

Wherein, M is selected from at least one of Ag, Au, Pt, Pd, and Cu metal nanoparticles.

X is in a range of 0<x≦0.2, preferably, x is in a range of 0.02≦x≦0.10.

“:” refers to doping and replacing, the luminescent material has luminescent substrate Li₂Ca₁₋ₓSiO₄:Tbₓ which is formed by doping Tb which partial replaces Ca in Li₂CaSiO₄ substrate. Trivalent Tb³⁺ ion is used as a luminescent center of the luminescent material.

M is doped in the luminescent substrate Li₂Ca₁₋ₓSiO₄:Tbₓ, and the silicate luminescent material has a general molecular formula of Li₂Ca₁₋ₓSiO₄:Tbₓ,M_{y} is formed by this doping.

Y is a molar ratio of M to Si and y is in a range of 0<y≦1×10⁻², preferably, y is in a range of 1×10⁻⁵≦y≦5×10⁻³.

The metal nanoparticles M is doped in the silicate luminescent material has a general molecular formula of Li₂Ca₁₋ₓSiO₄:Tbₓ,M_{y}, wherein metal nanoparticles M can improve internal quantum efficiency of the luminescent material, thereby improving luminescent intensity of the silicate luminescent material. In addition, the silicate luminescent material can prevent a phenomenon where luminescent efficiency of the luminescent material is reduced because a traditional sulfide and sulfur oxide decompose during use and sediment generated in decomposition covers a surface of the luminescent material, and has high stability.

In one embodiment of the present invention, a method for preparing a silicate luminescent material, comprising:

Step S110: preparing collosol containing M.

Said M is selected from at least one of Ag, Au, Pt, Pd, and Cu metal nanoparticles.

Said preparing collosol containing M comprising: mixing at least one solution of salt selected from silver salt solution, gold salt solution, platinum salt solution, palladium salt solution and copper salt solution, with assistant agent and reducing agent to have reaction to obtain collosol containing M. On the premise of obtaining collosol containing M, preferably, the reaction time is 10˜45 minutes for consideration of saving energy.

Solution of salt selected from silver salt solution, gold salt solution, platinum salt solution, palladium salt solution and copper salt solution can be chloride solution and nitrate solution of metal ion selected from silver, gold, platinum, palladium and copper. A concentration of at least one solution of salt selected from silver salt solution, gold salt solution, platinum salt solution, palladium salt solution and copper salt solution can be taken according to the actual needs flexiblely, preferably, the concentration of is in a range of 5×10⁻⁴ mol/L to 2.5×10⁻² mol/L.

The assistant agent is selected from at least one of polyvinyl pyrrolidone, sodium citrate, cetyl trimethyl ammonium bromide, sodium dodecyl sulfate and sodium dodecyl sulfonate. A concentration of said assistant agent in collosol containing M is in a range of 1×10⁻⁴ g/mL to 5×10⁻² g/mL.

The reducing agent is selected from at least one of hydrazine hydrate, ascorbic acid, sodium citrate and sodium borohydride. Preparing solution with reducing agent in which concentration of reducing agent is in range of 1×10⁻⁴ mol/L to 1 mol/L, and mixing reducing agent, at least one solution of salt selected from silver salt solution, gold salt solution, platinum salt solution, palladium salt solution and copper salt solution, and assistant agent to have reaction.

A molar ratio of said reducing agent to metal ions in at least one solution of salt selected from silver salt solution, gold salt solution, platinum salt solution, palladium salt solution and copper salt solution is in a range of 0.5:1 to 10:1.

With the help of reducing agent and assistant agent, metal ions of Ag, Au, Pt, Pd or Cu are reduced into metal nanoparticles of Ag, Au, Pt, Pd or Cu and dispersed in solvent, to obtain collosol containing M.

Step S120: mixing said collosol containing M and silicon dioxide aerogel to obtain mixture solution, stirring said mixture solution and then sonicating and drying, grinding solid material obtained from drying, calcining said solid material at 600° C. to 1200° C. for 0.5 to 4 hours to obtain silicon dioxide aerogel containing M.

Mixing said collosol containing M and silicon dioxide aerogel to obtain mixture solution, stirring said mixture solution at 50° C. to 75° C. for 0.5 to 3 hours, and sonicating for 10 minutes, to let the metal nanoparticles sufficiently adsorbed on silicon dioxide aerogel. Then drying at 60° C. to 150° C. to remove liquid from silicon dioxide aerogel. Followed is calcination at high temperature in order to remove the liquid completely, to obtain completely dried silicon dioxide aerogel containing M.

Step S130: selecting source compound of Li, source compound of Ca, source compound of Tb and said silicon dioxide aerogel containing M according to stoichiometric ratios of corresponding elements in general molecular formula of Li₂Ca₁₋ₓSiO₄:Tbₓ,M_{y}, mixing and grinding uniformly to form a mixture material, calcining said mixture material at raised temperature from 500° C. to 1000° C. for 2 to 15 hours, and reducing said mixture material at 800° C. to 1200° C. for 0.5 to 6 hours, cooling and grinding to obtain silicate luminescent material has a general molecular formula of Li₂Ca₁₋ₓSiO₄:Tbₓ,M_{y}, x is in a range of 0<x≦0.2, M is doped in said Li₂Ca₁₋ₓSiO₄:Tbₓ, and y is a molar ratio of M to Si and y is in a range of 0<y≦1×10⁻².

Source compound of Li is one of lithium oxide, lithium carbonate, lithium nitrate, lithium acetate and lithium oxalate, such as Li₂O, LiCO₃, Li₂C₂O₄.

Said source compound of Ca is one of calcium oxide, calcium carbonate, calcium nitrate, calcium acetate and calcium oxalate, such as CaO, CaCO₃, CaC₂O₄.

Said source compound of Tb is one of terbium oxide, terbium carbonate, terbium nitrate, terbium acetate and terbium oxalate, such as Tb₄O₇, Tb₂(CO₃)₃, Tb₂(C₂O₄)₃.

Using source compound of Li, source compound of Ca, source compound of Tb and silicon dioxide aerogel containing M as raw material, grinding and mixing uniformly before reaction proceed, to have the reaction proceeds more sufficiently. Grinding after twice calcining to make the silicate luminescent material obtained has small particles size and evenly distribution.

Said preparation methods of silicate luminescent material are of simple process, low demand on equipment, no pollution, easy to control, easy to produce in industry.

Special embodiments are disclosed as follows.

### Example 1

### Preparing Silicate Luminescent Material of Li₂Ca_{0.85} SiO₄:Tb_{0.15},Au_{1×10}_{^{−2}}

Preparation of Collosol Containing Au

Weighing 41.2 mg of AuCl₃HCl.4H₂O, dissolving it in 16.7 mL of deionized water; after AuCl₃HCl.4H₂O had been completely dissolved, weighing 14 mg of sodium citrate and 6 mg of cetyl trimethyl ammonium bromide and dissolving them in deionized water solution of AuCl₃HCl.4H₂O under magnetic stirring; weighing 1.9 mg of sodium borohydride and 17.6 mg of ascorbic acid and dissolving them into 10 mL of deionized water separately, then obtaining 10 mL sodium borohydride solution with concentrate of 5×10⁻³ mol/L and 10 mL of ascorbic acid solution with concentrate of 1×10⁻² mol/L. Adding 0.08 mL of sodium borohydride solution into deionized water solution of AuCl₃HCl.4H₂O, stirring for 5 min and then adding 3.22 mL of ascorbic acid solution with concentrate of 1×10⁻² mol/L into deionized water solution of AuCl₃HCl.4H₂O, and keep for reaction for 30 min, and obtaining 20 mL of collosol containing nanoparticles of Au in which the concentrate of Au is 5×10⁻³ mol/L.

Preparation of Silicon Dioxide Aerogel Containing Au

Weighing 0.3005 g of silicon dioxide aerogel, dissolving it in 10 ml of collosol containing nanoparticles of Au in which the concentrate of Au is 5×10⁻³ mol/L to obtain mixture solution, stirring mixture solution at 50° C. for 3 hours, and sonicating for 10 min, then drying at 60° C., grinding solid material obtained from drying, calcining said solid material at 600° C. for 4 hours to obtain silicon dioxide aerogel containing Au.

Preparation of Silicate Luminescent Material of Li₂Ca_{0.85}SiO₄:Tb_{0.15}, Au_{1×10}_{^{−2}}

Weighing 0.1195 g of Li_{z}°, 0.1904 g of CaO, 0.1121 g of Tb₄O₇ and 0.2405 g of silicon dioxide aerogel containing Au, grinding uniformly in agate mortar to form a mixture material powder, then placing the mixture material powder into corundum crucible, heating the mixture material powder in muffle furnace at 500° C. for 15 hours and then calcining in tube furnace under C powder reducing atmosphere at 1000° C. for 2 hours, cooling to room temperature, and grinding to obtain silicate luminescent material of Li₂Ca_{0.85} SiO₄: Tb_{0.15},Au_{1×10}_{^{−2}}.

### Example 2

### Preparing Silicate Luminescent Material of Li₂Ca_{0.98} SiO₄:Tb_{0.02},Pt_{5×10}_{^{−3}}

Preparation of Collosol Containing Pt

Weighing 25.9 mg of H₂PtCl₆.6H₂O, dissolving it in 17 mL of deionized water; after H₂PtCl₆.6H₂O had been completely dissolved, weighing 400 mg of sodium citrate and 600 mg of sodium dodecyl sulfonate and dissolving them in deionized water solution of H₂PtCl₆.6H₂O under magnetic stirring; weighing 1.9 mg of sodium borohydride and dissolving it into 10 mL of deionized water, then obtaining 10 mL sodium borohydride solution with concentrate of 5×10⁻³ mol/L, and prepare 10 mL of hydrazine hydrate solution with concentrate of 5×10⁻² mol/L. Adding 0.4 mL of sodium borohydride solution into deionized water solution of H₂PtCl₆.6H₂O, stirring for 5 min and then adding 2.6 mL of hydrazine hydrate solution with concentrate of 5×10⁻² mol/L into deionized water solution of H₂PtCl₆.6H₂O, and keep for reaction for 40 min, and obtaining 10 mL of collosol containing nanoparticles of Pt in which the concentrate of Pt is 2.5×10⁻³ mol/L.

Preparation of Silicon Dioxide Aerogel Containing Pt

Weighing 0.3005 g of silicon dioxide aerogel, dissolving it in 10 ml of collosol containing nanoparticles of Pt in which the concentrate of Pt is 2.5×10⁻³ mol/L to obtain mixture solution, stirring mixture solution at 75° C. for 0.5 hours, and sonicating for 10 min, then drying at 150° C., grinding solid material obtained from drying, calcining said solid material at 1200° C. for 0.5 hours to obtain silicon dioxide aerogel containing Pt.

Preparation of Silicate Luminescent Material of Li₂Ca_{0.98}SiO₄:Tb_{0.02},Pt_{5×10}_{^{−3}}

Weighing 0.2955 g of Li₂CO₃, 0.3924 g of CaCO₃, 0.0199 g of Tb₂(CO₃)₃ and 0.2404 g of silicon dioxide aerogel containing Pt, grinding uniformly in agate mortar to form a mixture material powder, then placing the mixture material powder into corundum crucible, heating the mixture material powder in muffle furnace at 1000° C. for 2 hours and then calcining in tube furnace under CO reducing atmosphere at 1200° C. for 0.5 hours, cooling to room temperature, and grinding to obtain silicate luminescent material of Li₂Ca_{0.98}SiO₄:Tb_{0.02},Pt_{5×10}_{^{−3}}.

### Example 3

### Preparing Silicate Luminescent Material of Li₂Ca_{0.90}SiO₄:Tb_{0.10},Ag_{2.5×10}_{^{−4}}

Preparation of Collosol Containing Ag

Weighing 3.4 mg of AgNO₃, dissolving it in 18.4 mL of deionized water; after AgNO₃ had been completely dissolved, weighing 42 mg of sodium citrate and dissolving it in deionized water solution of AgNO₃ under magnetic stirring; weighing 5.7 mg of sodium borohydride into 10 mL of deionized water separately, then obtaining 10 mL sodium borohydride solution with concentrate of 1.5×10⁻² mol/L. Adding 1.6 mL of sodium borohydride solution with concentrate of 1.5×10⁻² mol/L into deionized water solution of AgNO₃, and keep for reaction for 10 min, and obtaining 20 mL of collosol containing nanoparticles of Ag in which the concentrate of Ag is 1×10⁻³ mol/L.

Preparation of Silicon Dioxide Aerogel Containing Ag

Weighing 0.7212 g of silicon dioxide aerogel, dissolving it in 3 ml of collosol containing nanoparticles of Ag in which the concentrate of Ag is 1×10⁻³ mol/L to obtain mixture solution, stirring mixture solution at 60° C. for 2 hours, and sonicating for 10 min, then drying at 80° C., grinding solid material obtained from drying, calcining said solid material at 800° C. for 2 hours to obtain silicon dioxide aerogel containing Ag.

Preparation of Silicate Luminescent Material of Li₂Ca_{0.90}SiO₄:Tb_{0.10},Ag_{2.5×10}_{^{−4}}

Weighing 0.2955 g of Li₂CO₃, 0.2016 g of CaO, 0.0747 g of Tb₄O₂ and 0.2524 g of silicon dioxide aerogel containing Ag, grinding uniformly in agate mortar to form a mixture material powder, then placing the mixture material powder into corundum crucible, heating the mixture material powder in muffle furnace at 600° C. for 4 hours and then calcining in tube furnace under mixed gases of N₂ and H₂ reducing atmosphere at 1000° C. for 4 hours, cooling to room temperature, and grinding to obtain silicate luminescent material of Li₂Ca_{0.90}SiO₄:Tb_{0.10},Ag_{2.5×10}_{^{−4}}.

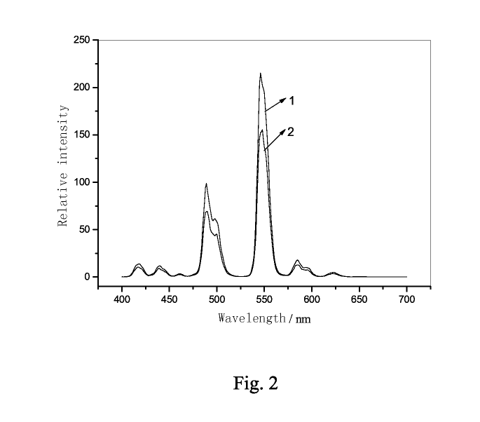

FIG. 2 is a cathodoluminescence spectrum of silicate luminescent material Li₂Ca_{0.90}SiO₄:Tb_{0.10},Ag_{2.5×10}_{^{−4}} excited by cathode ray under 3 kv acceleration voltage in Example 3 with respect to silicate luminescent material Li₂Ca_{0.90}SiO₄:Tb_{0.10} which is tested under the same conditions. Wherein, curve 1 is spectrum of silicate luminescent material Li₂Ca_{0.90}SiO₄:Tb_{0.10},Ag_{2.5×10}_{^{−4}}, and curve 2 is spectrum of silicate luminescent material Li₂Ca_{0.90}SiO₄:Tb_{0.10}.

### Example 4

Preparing Silicate Luminescent Material of Li₂Ca_{0.80}SiO₄:Tb_{0.20},Pd_{1×10}_{^{−5}}

Preparation of Collosol Containing Pd

Weighing 0.22 mg of PdCl₂.2H₂O, dissolving it in 10 mL of deionized water; after PdCl₂.2H₂O had been completely dissolved, weighing 11.0 mg of sodium citrate and 4.0 mg of sodium dodecyl sulfate and dissolving them in deionized water solution of PdCl₂.2H₂O under magnetic stirring; weighing 0.38 mg of sodium borohydride and dissolving it into 100 mL of deionized water, then obtaining sodium borohydride solution with concentrate of 1×10⁻⁴ mol/L. Adding 10 mL of sodium borohydride solution with concentrate of 1×10⁻⁴ mol/L into deionized water solution of PdCl₂.2H₂O under magnetic stirring, and keep for reaction for 20 min, and obtaining 20 mL of collosol containing nanoparticles of Pd in which the concentrate of Pd is 5×10⁻⁵ mol/L.

Preparation of Silicon Dioxide Aerogel Containing Pd

Weighing 0.9015 g of silicon dioxide aerogel, dissolving it in 3 ml of collosol containing nanoparticles of Pd in which the concentrate of Pd is 5×10⁻⁵ mol/L to obtain mixture solution, stirring mixture solution at 65° C. for 1.5 hours, and sonicating for 10 min, then drying at 120° C., grinding solid material obtained from drying, calcining said solid material at 1100° C. for 2 hours to obtain silicon dioxide aerogel containing Pd.

Preparation of Silicate Luminescent Material of Li₂Ca_{0.80}SiO₄:Tb_{0.20},Pd_{1×10}_{^{−5}}

Weighing 0.4076 g of Li₂C₂O₄, 0.4096 g of CaC₂O₄, 0.2327 g of Tb₂(C₂O₄)₃ and 0.2404 g of silicon dioxide aerogel containing Pd, grinding uniformly in agate mortar to form a mixture material powder, then placing the mixture material powder into corundum crucible, heating the mixture material powder in muffle furnace at 700° C. for 5 hours and then calcining in tube furnace under pure H₂ reducing atmosphere at 800° C. for 6 hours, cooling to room temperature, and grinding to obtain silicate luminescent material of Li₂Ca_{0.80}SiO₄:Tb_{0.20},Pd_{1×10}_{^{−5}}.

### Example 5

### Preparing Silicate Luminescent Material of Li₂Ca_{0.95}SiO₄:Tb_{0.05},CU_{1×10}_{^{−4}}

Preparation of Collosol Containing Cu

Weighing 1.6 mg of Cu(NO₃)₂, dissolving it in 16 mL of ethanol; after Cu(NO₃)₂ had been completely dissolved, weighing 12 mg of polyvinyl pyrrolidone and dissolving it in ethanol solution of Cu(NO₃)₂ under stirring; weighing 0.4 mg of sodium borohydride in 10 mL of ethanol, then obtaining 10 mL sodium borohydride solution with concentrate of 1×10⁻³ mol/L. Keep for reaction for 10 min, and obtaining 20 mL of collosol containing nanoparticles of Cu in which the concentrate of Cu is 4×10⁻⁴ mol/L.

Preparation of Silicon Dioxide Aerogel Containing Cu

Weighing 0.7212 g of silicon dioxide aerogel, dissolving it in 3 ml of collosol containing nanoparticles of Cu in which the concentrate of Cu is 4×10⁻⁴ mol/L to obtain mixture solution, stirring mixture solution at 65° C. for 1.5 hours, and sonicating for 10 min, then drying at 110° C., grinding solid material obtained from drying, calcining said solid material at 900° C. for 3 hours to obtain silicon dioxide aerogel containing Cu.

Preparation of Silicate Luminescent Material of Li₂Ca_{0.95}SiO₄:Tb_{0.05},Cu_{1×10}_{^{−4}}

Weighing 0.5516 g of LiNO₃, 0.6232 g of Ca(NO₃)₂, 0.0689 g of Tb(NO₃)₃ and 0.2404 g of silicon dioxide aerogel containing Cu, grinding uniformly in agate mortar to form a mixture material powder, then placing the mixture material powder into corundum crucible, heating the mixture material powder in muffle furnace at 600° C. for 4 hours and then calcining in tube furnace under mixed gases of N₂ and H₂ reducing atmosphere at 1000° C. for 6 hours, cooling to room temperature, and grinding to obtain silicate luminescent material of Li₂Ca_{0.95}SiO₄:Tb_{0.05},Cu_{1×10}_{^{−4.}}

### Example 6

### Preparing Silicate Luminescent Material of Li₂Ca_{0.88}SiO₄:Tb_{0.12},Ag_{5×10}_{^{−4}}

Preparation of Collosol Containing Ag

Weighing 0.0429 mg of AgNO₃, 2.932 mg sodium citrate and 0.05 g PVP separately, and preparing 10 mL AgNO₃ solution with concentrate of 0.025 mol/L, 10 mL sodium citrate solution with concentrate of 1 mol/L and 10 mL PVP solution with concentrate of 5 mg/mL separately. Adding 2 mL AgNO₃ solution into 30 mL deionized water and then adding 4 mL said PVP solution, stirring, heating at 100° C., and then adding 4 mL sodium citrate solution, keep for reaction for 15 min, and obtaining 40 mL of collosol containing nanoparticles of Ag in which the concentrate of Ag is 1.25×10³ mol/L.

Preparation of Silicon Dioxide Aerogel Containing Ag

Weighing 0.6010 g of silicon dioxide aerogel, dissolving it in 4 ml of collosol containing nanoparticles of Ag in which the concentrate of Ag is 1.25×10⁻⁵ mol/L to obtain mixture solution, stirring mixture solution at 70° C. for 1 hours, and sonicating for 10 min, then drying at 80° C., grinding solid material obtained from drying, calcining said solid material at 800° C. for 3 hours to obtain silicon dioxide aerogel containing Ag.

Preparation of Silicate Luminescent Material of Li₂Ca_{0.88}SiO₄:Tb_{0.12},Ag_{5×10}_{^{−4}}

Weighing 0.2955 g of Li₂CO₃, 0.4506 g of CaC₂O₄, 0.1396 g of Tb₂(C₂O₄)₃ and 0.2404 g of silicon dioxide aerogel containing Ag, grinding uniformly in agate mortar to form a mixture material powder, then placing the mixture material powder into corundum crucible, heating the mixture material powder in muffle furnace at 500° C. for 10 hours and then calcining in tube furnace under pure H₂ reducing atmosphere at 1100° C. for 3 hours, cooling to room temperature, and grinding to obtain silicate luminescent material of Li₂Ca_{0.88}SiO₄:Tb_{0.12},Ag_{5×10}_{^{−4}}.

### Example 7

### Preparing Silicate Luminescent Material of Li₂Ca_{0.92}SiO₄:Tb_{0.08}, (Ag_{0.5}/Au_{0.5})_{1.25×10}_{^{−3}}

Preparation of Collosol Containing Ag and Au

Weighing 6.2 mg of AuCl₃HCl.4H₂O and 2.5 mg of AgNO₃, dissolving them in 28 mL of deionized water; after they had been completely dissolved, weighing 22 mg of sodium citrate and 20 mg PVP and dissolving them in deionized water solution of AuCl₃HCl.4H₂O and AgNO₃ under magnetic stirring; weighing 5.7 mg of sodium borohydride and dissolving it into 10 mL of deionized water separately, then obtaining 10 mL sodium borohydride solution with concentrate of 1.5×10⁻² mol/L. Adding 2 mL of sodium borohydride solution with concentrate of 1.5×10⁻² mol/L into deionized water solution of AuCl₃HCl.4H₂O and AgNO₃, and keep for reaction for 20 min, and obtaining 30 mL of collosol containing nanoparticles of Ag and Au in which the total concentrate of metal of Ag and Au is 1×10⁻³ mol/L.

Preparation of Silicon Dioxide Aerogel Containing Ag and Au

Weighing 0.4808 g of silicon dioxide aerogel, dissolving it in 10 ml of collosol containing nanoparticles of Ag and Au in which the concentrate of Ag and Au is 1×10⁻³ mol/L to obtain mixture solution, stirring mixture solution at 75° C. for 1 hours, and sonicating for 10 min, then drying at 100° C., grinding solid material obtained from drying, calcining said solid material at 1000° C. for 4 hours to obtain silicon dioxide aerogel containing Ag and Au.

Preparation of Silicate Luminescent Material of Li₂Ca_{0.92}SiO₄:Tb_{0.08}, (Ag_{0.5}/Au_{0.5})_{1.25×10}_{^{−3}}

Weighing 0.5279 g of CH₃COOLi, 0.5821 g of (CH₃COO)₂Ca, 0.1075 g of (CH₃COO)₃Tb and 0.2524 g of silicon dioxide aerogel containing Ag and Au, grinding uniformly in agate mortar to form a mixture material powder, then placing the mixture material powder into corundum crucible, heating the mixture material powder in muffle furnace at 700° C. for 8 hours and then calcining in tube furnace under mixed gases of N₂ and H₂ reducing atmosphere at 900° C. for 5 hours, cooling to room temperature, and grinding to obtain silicate luminescent material of Li₂Ca_{0.92}SiO₄:Tb_{0.08}, (Ag_{0.5}/Au_{0.5})_{1.25×10}_{^{−3}}.

While the present invention has been described with reference to particular embodiments, it will be understood that the embodiments are illustrative and that the invention scope is not so limited. Alternative embodiments of the present invention will become apparent to those having ordinary skill in the art to which the present invention pertains. Such alternate embodiments are considered to be encompassed within the scope of the present invention. Accordingly, the scope of the present invention is described by the appended claims and is supported by the foregoing description.

What is claimed is:

1. A silicate luminescent material, wherein said silicate luminescent material has a general molecular formula of Li₂Ca₁₋ₓSiO₄:Tbₓ,M_{y}, M is selected from at least one of Ag, Au, Pt, Pd, and Cu metal nanoparticles, x is in a range of 0<x≦0.2, M is doped in said silicate luminescent material, and y is a molar ratio of M to Si and y is in a range of 0<y≦1×10⁻².

2. The silicate luminescent material as in claim 1, wherein said x is in a range of 0.02≦x≦0.10.

3. The silicate luminescent material as in claim 1, wherein said y is in a range of 1×10⁻⁵≦y≦5×10⁻³.

4. A method for preparing a silicate luminescent material, comprising:
preparing collosol containing M, said M is selected from at least one of Ag, Au, Pt, Pd, and Cu metal nanoparticles;
mixing said collosol containing M and silicon dioxide aerogel to obtain mixture solution, stirring said mixture solution and then sonicating and drying, grinding solid material obtained from drying, calcining said solid material at 600° C. to 1200° C. for 0.5 to 4 hours to obtain silicon dioxide aerogel containing M;
selecting source compound of Li, source compound of Ca, source compound of Tb and said silicon dioxide aerogel containing M according to stoichiometric ratios of corresponding elements in general molecular formula of Li₂Ca₁₋ₓSiO₄:Tbₓ,M_{y}, mixing and grinding uniformly to form a mixture material, calcining said mixture material at 500° C. to 1000° C. for 2 to 15 hours, and reducing said mixture material at 800° C. to 1200° C. for 0.5 to 6 hours, cooling and grinding to obtain silicate luminescent material has a general molecular formula of Li₂Ca₁₋ₓSiO₄:Tbₓ,M_{y}, x is in a range of 0<x≦0.2, M is doped in said Li₂Ca₁₋ₓSiO₄:Tbₓ, and y is a molar ratio of M to Si and y is in a range of 0<y≦1×10⁻².

5. The method for preparing said silicate luminescent material as in claim 4, wherein said preparing collosol containing M comprising: mixing at least one solution of salt selected from silver salt solution, gold salt solution, platinum salt solution, palladium salt solution and copper salt solution, with assistant agent and reducing agent to have reaction for 10˜45 minutes to obtain collosol containing M.

6. The method for preparing said silicate luminescent material as in claim 5, wherein a concentration of at least one solution of salt selected from silver salt solution, gold salt solution, platinum salt solution, palladium salt solution and copper salt solution is in a range of 5×10⁻⁴ mol/L to 2.5×10⁻² mol/L.

7. The method for preparing said silicate luminescent material as in claim 4, wherein said assistant agent is selected from at least one of polyvinyl pyrrolidone, sodium citrate, cetyl trimethyl ammonium bromide, sodium dodecyl sulfate and sodium dodecyl sulfonate;
a concentration of said assistant agent in collosol containing M is in a range of 1×10⁻⁴ g/mL to 5×10⁻² g/mL;
said reducing agent is selected from at least one of hydrazine hydrate, ascorbic acid, sodium citrate and sodium borohydride;
a molar ratio of said reducing agent to metal ion in at least one solution of salt selected from silver salt solution, gold salt solution, platinum salt solution, palladium salt solution and copper salt solution is in a range of 0.5:1 to 10:1.

8. The method for preparing said silicate luminescent material as in claim 4, wherein said stirring mixture and then sonicating and drying comprising: stirring said mixture solution at 50° C. to 75° C. for 0.5 to 3 hours, and sonicating for 10 minutes, then drying at 60° C. to 150° C.

9. The method for preparing said silicate luminescent material as in claim 4, wherein said source compound of Li is one of lithium oxide, lithium carbonate, lithium nitrate, lithium acetate and lithium oxalate, said source compound of Ca is one of calcium oxide, calcium carbonate, calcium nitrate, calcium acetate and calcium oxalate, and said source compound of Tb is one of terbium oxide, terbium carbonate, terbium nitrate, terbium acetate and terbium oxalate.

10. The method for preparing said silicate luminescent material as in claim 4, wherein said reducing at 800° C. to 1200° C. for 0.5 to 6 hours comprising: reducing under reducing atmosphere at 800° C. to 1200° C. for 0.5 to 6 hours, and said reducing atmosphere is selected from at least one of mixed gases of N₂ and H₂ reducing atmosphere, CO reducing atmosphere, and H₂ reducing atmosphere.
